(19) United States
(12) Patent Application Publication
(10) Pub. No.: US 2004/0091717 A1
(43) Pub. Date: May 13, 2004

(54) Nitrogen-free fluorine-doped silicate glass

(75) Inventors: Ming Li, West Linn, OR (US); Yang Zhuang, West Linn, OR (US); Jason L. Tian, West Linn, OR (US); Zhiyuan Fang, West Linn, OR (US)

Correspondence Address: PATTON BOGGS, 1660 LINCOLN ST, SUITE 2050, DENVER, CO, 80264, US

(73) Assignee: Novellus Systems, Inc., San Jose, CA

(21) Appl. No.: 10/294,301

(22) Filed: Nov. 13, 2002

(51) Int. Cl. H05H 1/24; B32B 17/06

(52) U.S. Cl. 428/426; 427/579

(57) ABSTRACT

Nitrogen-free reactant gas containing silicon, oxygen, and fluorine atoms is flowed to a nitrogen-free CVD reaction chamber. Preferably, SiH₄ gas, SiF₄ gas, and CO₂ are flowed to the reaction chamber. Radio-frequency power is applied to form a plasma. Preferably, the reaction chamber is part of a dual-frequency PECVD or HPD-CVD apparatus. Reactive components formed in the plasma react to form low-dielectric-constant nitrogen-free fluorine-doped silicate glass (FSG) on a substrate surface.

### FIELD OF THE INVENTION

The invention is related to the field of low-dielectric insulator layers in integrated circuits, in particular, to fluorine-doped silicate glass.

### BACKGROUND OF THE INVENTION

1. Statement of the Problem

As the density of integrated circuits increases and feature sizes become smaller, resistance-capacitance (RC) coupling and resulting RC delays become more of a problem. Since capacitance is directly proportional to the dielectric constant (“k”), RC problems can be reduced if a low-dielectric-constant material is used as insulating material. Fluorine-doped silicate glass, or fluorosilicate glass (“FSG”), has been identified as a good insulator material with a dielectric constant, k, less than 3.7. In the prior art, several processes for depositing FSG on an integrated circuit substrate have been tried. Some of these are discussed in U.S. Pat. No. 5,876,798, issued Mar. 2, 1999 to Vassiliev, which is hereby incorporated by reference.

One representative prior-art process involves reaction of SiH₄, SiF₄, and N₂O gases in a plasma-enhanced CVD (PECVD) reactor. A mixture including SiH₄ and oxygen gas, O₂, is avoided in PECVD reactors because of its extremely high reactivity and the danger of explosion.

Another representative process involves reaction of fluorotriethoxysilane (“FTES”), tetraethyloxysilane (“TEOS”) with oxygen gases (02 and ozone) and nitrogen gases in a PECVD or high-density plasma CVD (“HDP-CVD”) reactor. Alternatively, N₂O gas, another strong oxidizer, may be used instead of O₂ gas. It is generally believed in the field that N₂ gas, N₂O gas, or some other nitrogen source is useful for enhancing the stability of the deposited FSG. See, for example, U.S. Pat. No. 6,077,764, issued Jun. 20, 2000 to Sugiarto et al., and U.S. Pat. No. 6,303,518 B1, issued Oct. 16, 2001 to Tian et al.

FSG layers inevitably contain embedded nitrogen atoms when the layers are formed in plasma systems containing nitrogen, from N₂O reaction gas or from N₂ or some other nitrogen source added to stabilize FSG. Nitrogen-containing components in a FSG layer, however, may cause problems when Deep Ultra-Violet (“DUV”) lithography techniques (e.g., at 248 nm, 193 nm, and shorter wavelengths) are used to pattern FSG layers; for example, in dual damascene applications. The nitrogen species present in a FSG layer as amine groups (—NH₂) and similar nitrogen-groups may cause photo-resist poisoning, resulting in uncompleted lithography processes.

### SUMMARY OF THE INVENTION

The invention helps to solve some of the problems mentioned above by providing nitrogen-free FSG and a method for producing it. Nitrogen-free FSG layers in accordance with the invention are useful as insulator layers in a wide variety of applications, in particular, in integrated circuit structures, such as intermetal dielectric layers, interlayer dielectric layers, and capping layers.

In one aspect of the invention, a nitrogen-free fluorosilicate glass in accordance with the invention comprises a Si—O bond and a Si—F bond, but is further characterized in being nitrogen-free.

In another aspect, a method of forming nitrogen-free fluorosilicate glass comprises flowing nitrogen-free gases containing silicon atoms, oxygen atoms, and fluorine atoms to a nitrogen-free reaction chamber, and forming a plasma containing silicon atoms, oxygen atoms, and fluorine atoms in the reaction chamber. Typically, the reaction chamber is part of a PECVD or a HDP-CVD apparatus. Flowing nitrogen-free gases typically comprises flowing gaseous silicon-containing molecules, gaseous oxygen-containing molecules, and gaseous fluorine-containing molecules into the reaction chamber. In another aspect, flowing nitrogen-free gases comprises flowing a nitrogen-free gas selected from the group consisting of TEOS, TMOS, and tetramethylsilane; flowing a nitrogen-free oxidizer gas selected from the group consisting of CO₂, CO, methanol, H₂O, O₂, and O₃; and flowing a nitrogen-free fluorine-containing gas selected from the group consisting of CF₄, C₂F₆, C₄F₈, CHF₃, and CH₂F₂. Preferably, flowing nitrogen-free gases comprises flowing SiH₄ gas, flowing a nitrogen-free oxidizer gas, and flowing SiF₄ gas. Preferably, the nitrogen-free oxidizer gas comprises a relatively weak oxidizer, such as CO₂.

In one aspect, flowing SiH₄, CO₂, and SiF₄ gases into a PECVD reaction chamber is conducted at a relative flow rate ratio SiH₄/CO₂/SiF₄ in ranges of about from 1/30/2 to 1/500/40. Preferably, a relative flow rate ratio SiH₄/CO₂/SiF₄ is in a range of about from 1/40/3 to 1/90/10, most preferably about 1/90/4.

In one aspect, a method in accordance with the invention comprises maintaining a process pressure in a PECVD reaction chamber in a range of about from 0.1 Torr to 30 Torr, preferably at about 3.25 Torr. In another aspect, the temperature of a substrate in a PECVD reaction chamber is maintained in a range of about from 200° C. to 500° C., preferably in a range of about from 350° C. to 450° C. In another aspect, forming a plasma in a PECVD reaction chamber comprises applying high-frequency radio-frequency power to the reaction chamber, generally in a range of about from 1 MHz to 100 MHz, and typically in a range of about from 2 MHz to 30 MHz. Applying high-frequency radio-frequency power in a PECVD reaction chamber typically comprises applying power in a range of about from 0.2 Watts per cm² to 5 Watts per cm² of a substrate surface. In another aspect, forming a plasma in a PECVD reaction chamber comprises applying low-frequency radio-frequency power to the reaction chamber, typically at a frequency in a range of about from 100 kHz to 1 MHz, and in a power range of about from 0.2 Watts per cm² to 5 Watts per cm² of a substrate surface.

In one aspect, the reaction chamber is a HDP-CVD reaction chamber, and a method in accordance with the invention comprises maintaining a process pressure in the reaction chamber in a range of about from 2 mTorr to 10 mtorr. In another aspect, the temperature of a substrate in the reaction chamber is maintained in a range of about from 200° C. to 450° C. In another aspect, in a method using a HDP-CVD technique, forming a plasma comprises applying low-frequency radio-frequency power to the reaction chamber, typically at a frequency in a range of about from 2 MHz to 10 MHz. In another aspect, applying low-frequency radio-frequency power comprises applying power in a range of about from 5 Watts per cm² to 18 Watts per cm² of a substrate surface. In still another aspect, forming a plasma in a HDP-CVD reaction chamber comprises applying high-frequency radio-frequency power to the substrate, preferably at a frequency of about 13.56 MHz, and in a range of about from 1 Watt per cm² to 8 Watts per cm² of a substrate.

In another aspect, flowing nitrogen-free gases containing silicon atoms, oxygen atoms and fluorine atoms into a HDP-CVD reaction chamber comprises flowing CO₂ gas and flowing SiF₄ gas. In still another aspect, SiH₄ gas is flowed into the reaction chamber.

### BRIEF DESCRIPTION OF THE DRAWINGS

A more complete understanding of the invention may be obtained by reference to the drawings, in which:

FIG. 1 depicts in schematic form a section of an integrated circuit wafer containing a N-free FSG layer in accordance with the invention;

FIG. 2 depicts the section of FIG. 1 in a later phase of fabrication in which the FSG layer has been removed and a second N-free FSG layer covers the surface;

FIG. 3 depicts in schematic form a CVD apparatus suitable for depositing a nitrogen-free low-dielectric-constant FSG layer by a PECVD method in accordance with the invention;

FIG. 4 contains a flow chart of an embodiment of a preferred method in accordance with the invention;

FIG. 5 shows the results of a FTIR analysis of an exemplary N-free FSG layer fabricated in accordance with the invention; and

FIG. 6 shows a SIMS profile of a thin-film structure containing a N-free FSG layer in accordance with the invention.

### DESCRIPTION OF THE INVENTION

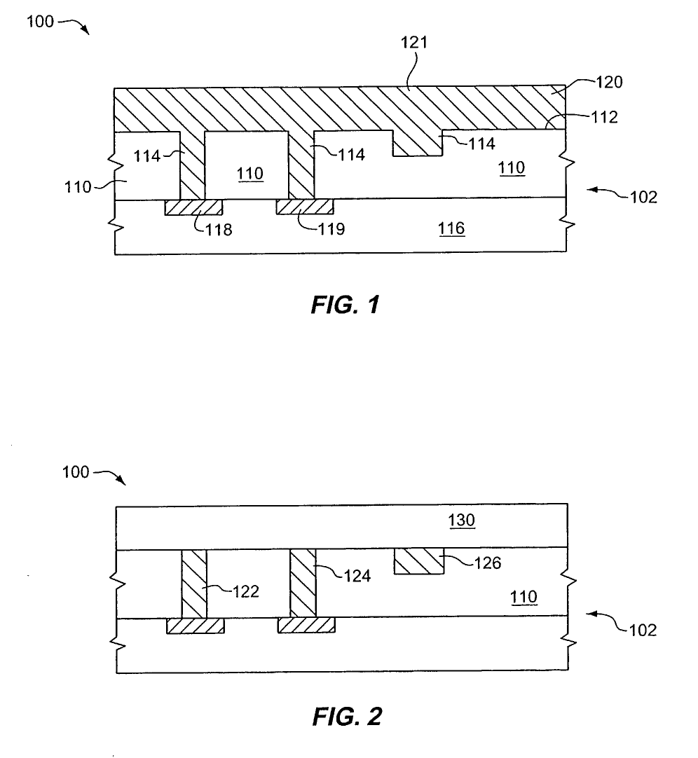

The invention is described herein with reference to FIGS. 1-6. It should be understood that the structures and systems depicted in schematic form in FIGS. 1-4 serve explanatory purposes and are not precise depictions of actual structures and systems in accordance with the invention. Furthermore, the embodiments described herein are exemplary and are not intended to limit the scope of the invention, which is defined in the claims below.

FIG. 1 depicts in schematic form a section 100 of an integrated circuit wafer 102 containing a nitrogen-free fluorosilicate glass layer 110 in accordance with the invention. The term “fluorosilicate glass” is well known in the art and is essentially synonymous with the term “fluorine-doped silicate glass”. Both are abbreviated “FSG”. The terms “nitrogen-free”, “N-free”, and related terms in this specification mean substantially nitrogen-free. Substantially nitrogen-free FSG contains no or only trace amounts of nitrogen. For example, preferably, any nitrogen species in N-free FSG in accordance with the invention is present below the current detectable limit as measured using Secondary Ion Mass Spectrometry analysis (SIMS), which is generally 1 ppm or less. A nitrogen-free reactor chamber contains no or only trace amounts of nitrogen atoms during the N-free FSG film deposition. N-free FSG insulator layer 110 contains unetched surface portion 112 and etched portions 114. Section 100 includes a device layer 116, typically containing dielectric or semiconductor material. Active components 118, 119 represent active devices or electrical connectors. Metal layer 120 has been formed on FSG layer 110, upper metal layer 121 covering surface portion 112, and lower parts of metal layer 120 filling etched portions 114. FIG. 2 depicts section 100 in a later phase of fabrication. Metal layer 120 has been removed from surface 112, thereby forming metal lines 122, 124, 126. Thus, FSG 110 serves as an intermetal dielectric layer between metal lines 122 and 124. A N-free FSG layer 130 has been deposited in accordance with the invention over FSG insulator layer 110 and metal lines 122, 124, 126. Thus, FSG layer 130 serves as a capping layer, or alternatively, it may be etched or otherwise processed for additional features and serve as another intermediate insulating layer. Generally, a barrier layer (not shown) is formed between a metal layer and a dielectric layer in accordance with the invention.

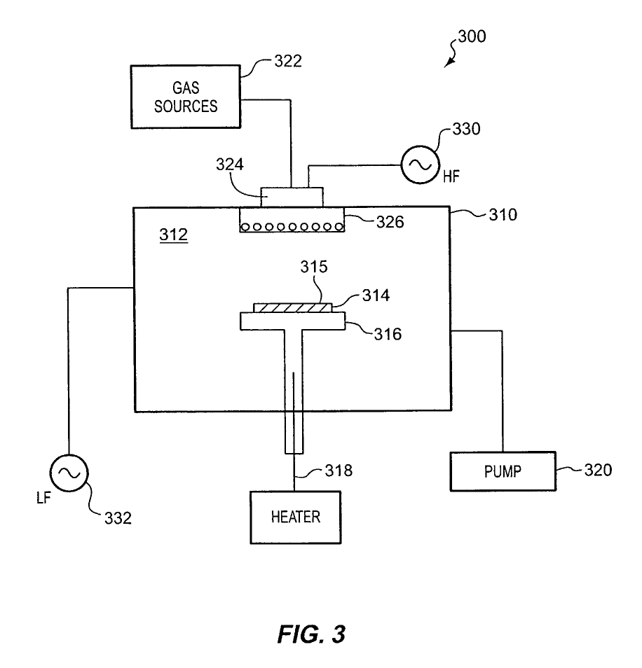

FIG. 3 depicts in schematic form a CVD apparatus 300 suitable for depositing a nitrogen-free low-dielectric-constant FSG layer by a plasma-enhanced CVD (“PECVD”) method in accordance with the invention. Apparatus 300 includes a reaction chamber 310 having a chamber interior 312 capable of holding one or more substrates 314 having an upper surface 315 on which a layer of N-free FSG is to be deposited. Substrate 314 is supported in chamber 310 on substrate holder 316. Substrate holder 316 is functionally coupled with a heating unit 318 for heating substrate 314 to a desired temperature. Generally, the substrate is maintained at a temperature in a range of about from 200° C. to 500° C., preferably in a range of about 300° C. to 450° C. As is typical in such chambers, the reactor chamber interior 312 is evacuated or pressurized as desired by a suitable pump apparatus schematically represented in FIG. 3 as pump 320. In a method in accordance with the invention, pressures in the reaction chamber generally are maintained in a range of about from 0.1 Torr to 30 Torr, preferably in a range of about from 1 Torr to 5 Torr.

Selected gases used in a method in accordance with the invention are introduced into interior 312 of reaction chamber 310 from gas sources 322 through a gas delivery system 324. Typically, the gases are introduced into the reaction chamber interior 312 through one or more showerheads 326, depending on details of the reactor design. Generally, gas sources 322 include separate sources of gaseous reactants. In some embodiments, a gas source includes a liquid which is gasified using conventional techniques to provide a reactant gas for the CVD reaction. The flow rates of the reactants are typically controlled by volumetric flow rate controllers using techniques known in the art.

In one basic embodiment in accordance with the invention, N-free FSG is produced by flowing one or more gaseous reactant streams containing silicon, oxygen, and fluorine atoms to the reaction chamber, and forming a plasma from the resulting reactant gas mixture. In certain embodiments, gases introduced into the reaction chamber additionally include carbon atoms, hydrogen atoms, and/or one or more inert gases. In certain embodiments, reactant molecules are gasified from a liquid source prior to being flowed to the reaction chamber.

Preferred gaseous silicon-containing precursor molecules include: silane, SiH₄; an organosilicate compound, for example, tetraethylorthosilicate (TEOS) and tetramethylorthosilicate (TMOS); an organosilane, such as tetramethylsilane and phenylsilane; and fluorinated reactants, such as silicon tetrafluoride, SiF₄. In certain embodiments, organic groups on organosilicate or organosilane precursor compounds are aromatic or aliphatic. Alternatively, mixtures of the aforementioned compounds, or mixed compounds, in which some organic substituents are bonded to silicon through an oxygen linkage and others are attached directly to silicon, such as alkylalkoxysilanes, are used as silicon precursors.

Suitable gaseous oxygen-containing precursor molecules include essentially any chemical species that contains oxygen and does not contain nitrogen. For example, suitable sources of oxygen include carbon dioxide, carbon monoxide, methanol, water, and the like. Molecular oxygen gas, O₂ (usually in pure form), or other strong oxidizer, such as ozone, is also suitable for use in a HDP-CVD reactor. In a PECVD reaction chamber, a strong oxidizer like O₂-gas is usually only used with a relatively large highly-substituted organosilicon compound like TEOS as the silicon source; but O₂-gas is not used with SiH₄ or other reactive, relatively unsubstituted silanes.

In certain embodiments, a silicon and/or an oxygen source also functions as a source of carbon. Alternatively, a separate carbon source, such as methane, is used in producing the N-free FSG. Virtually any carbon source is useful as a source of carbon, provided that it does not contain nitrogen.

Suitable gaseous fluorine-containing precursor molecules include essentially any fluorine-containing gases not having nitrogen components. Preferably, a fluorine precursor contains only fluorine and one or more of silicon, carbon, hydrogen, and oxygen. Typical fluorine precursors include, for example: silicon tetrafluoride (SiF₄); a fluorine-carbon compound, such as tetrafluoromethane (CF₄); hexafluoroethane (C₂F₆); octafluorocyclobatane (C₄F₈); or a fluorine-hydrogen-carbon species, such as trifluoromethane (CHF₃) or difluoromethane (CH₂F₂).

Plasma discharge is sustained by energy applied to reaction chamber 310 through a high-frequency (“HF”) generator 330, which supplies HF radio-frequency (“RF”) power. Typically, the HF RF plasma energy used is 13.56 MHz, although the invention is not limited to any exact frequency value. Generally, the HF RF has a frequency in a range of about from 1 MHz to 100 MHz, preferably 2 MHz to 30 MHz. HF RF power is generally applied on showerhead 326 at a level of about 0.2 Watts per cm² to 5 Watts per cm² of substrate surface. The reactive precursors formed in the plasma react to form N-free FSG on the substrate surface. In a preferred embodiment of a method in accordance with the invention, a dual-frequency chamber also provides low-frequency radio-frequency (“LF RF”) power to the plasma. As depicted in FIG. 3, CVD apparatus 300 includes LF generator 332 for supplying low-frequency power to the plasma between showerhead 326 and substrate 314. The LF RF power is generally applied either on showerhead 326 or substrate holder 316. Generally, the LF RF has a frequency in a range of about from 100 kHz to 1 MHz, preferably about 250 kHz. LF RF power is generally applied at a level of about 0.2 Watts per cm² to 5 Watts per cm² of substrate surface. With respect to applying HF and LF power, the term “to the reaction chamber” is used here in a broad sense. For example, HF power generator supplies power to the reactant gas mixture flowing from gas delivery system 324 into showerhead 326, as depicted in FIG. 3, or alternatively, it supplies power in showerhead 326 or in reaction chamber interior 312. Similarly, LF RF generator 332 applies power to the reaction chamber at an appropriate location, for example, to a showerhead or to a substrate holder.

Similarly, with respect to introducing or flowing gases and gaseous molecules “to the reaction chamber”, the term “to the reaction chamber” and related terms are used broadly to mean towards and up to the reaction chamber or into the reaction chamber depending on where plasma-forming power is applied in a particular CVD apparatus used in accordance with the invention. For example, in certain embodiments in accordance with the invention, plasma-initiating power is applied to a gaseous stream prior to its entry into the reaction chamber, so that molecules originally present in the gaseous stream are already broken up into reactive components upon actual entry into the reaction chamber.

In certain embodiments in accordance with the invention, nonreactive carrier gas is used to carry reactant gas to the reaction chamber and also to help gasify liquid precursor compounds. Suitable nonreactive gases include noble gases, such as neon, helium, and argon. In certain embodiments, introduction of non-nitrogen inert gases into the reaction chamber functions to adjust FSG-film uniformity, to stabilize the plasma, to improve film stability, to adjust film stress, and to adjust the dielectric constant. For example, an inert-gas flow rate about 5 to 10 times greater than the flow rate of SiH₄ into a PECVD reaction chamber causes about a ten percent increase in film stress compared to the stress when no inert gas is fed into the reactor chamber.

By adjusting variables such as composition and flow rates of reactant gases, power level, deposition pressure, and temperature, N-free FSG film composition and properties can be modified. Atomic concentrations of a N-free FSG layer in accordance with the invention are typically in the following approximate ranges: 1% to 10% hydrogen; 20% to 35% silicon; 40% to 70% oxygen; and 2% to 15% fluorine. Good-quality N-free FSG layers having a dielectric constant in a range of about from 3.0 to 3.7 can be deposited at a rate in a range of about 50 nm/min to more than 700 nm/min. The N-free FSG layers in accordance with the invention are thermally stable in process conditions typically used in semiconductor manufacturing. Therefore, thin-film properties of dielectric constant, k, and film stress do not vary significantly during and after subsequent semiconductor manufacturing operations.

In certain preferred embodiments in accordance with the invention, SiH₄, CO₂, and SiF₄ gases are introduced into a reaction chamber. Typically, the relative flow rate ratio SiH₄/CO₂/SiF₄ is in ranges of about from 1/30/2 to 1/500/40, and more preferably in ranges of about from 1/40/3 to 1/90/10.

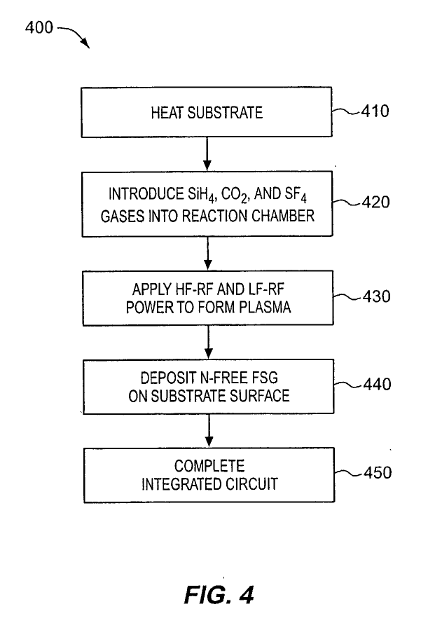

FIG. 4 contains a generalized flow chart 400 of a preferred method in accordance with the invention. In processes 410, a substrate is heated to a temperature in a range of about 350° C. to 450° C. Preferably, a heater in the substrate holder heats the wafer and maintains its temperature. The substrate surface comprises base silicon or one or more other integrated circuit layers. In processes 420, nitrogen-free reactant gases containing silicon, oxygen, and fluorine are flowed into a nitrogen-free PECVD reaction chamber, as described above. Preferably SiH₄, CO₂, and SiF₄, at relative flow rate ratios SiH₄/CO₂/SiF₄ of about 1/90/4, are introduced into the reaction chamber. Optionally, helium gas or another non-nitrogen inert gas is also flowed into the reaction chamber at a flow rate ratio SiH₄/He in a range of about 1/10 to 1/5. In processes 430, HF RF power (13.56 MHz, 0.5 W/cm²) and LF RF (250 kHz, 0.5 W/cm²) are applied to ignite and sustain the plasma discharges. As a result, in processes 440, N-free FSG deposits on the substrate surface. Preferably, a N-free FSG film in accordance with the invention is deposited as a series of N-free FSG sublayers, each of which is formed at one of a sequence of processing stations in a multi-station PECVD apparatus. For example, a method in accordance with the invention is practiced in commercially available-multiple-station CVD units, such as the Concept One, Concept One MAXUS™, Concept Two SEQUEL ExpresS™, Concept Two Dual SEQUEL Express™, Concept Three SEQUEL™, and VECTOR™ System plasma-enhanced-chemical vapor ™ deposition (PECVD) units; or the Concept Two SPEED™, Concept Two SPEED/SEQUEL™, or Concept Three SPEED high-density plasma (HDP) CVD units, which are manufactured by Novellus Systems, Inc. of San Jose, Calif. Nevertheless, methods of making N-free FSG films in accordance with the invention are not limited to multiple-station CVD systems, such as described above. N-free FSG in accordance with the invention is fabricated also using single-station units known in the art. During fabrication, processes 410, 420, 430 and 440 are conducted or occur essentially simultaneously. After deposition of the FSG layer is completed in processes 440, further processing of an integrated circuit wafer is continued in steps 450.

### EXAMPLE 1

An exemplary N-free FSG layer was fabricated using a PECVD method in accordance with the invention. The N-free FSG film was deposited on a 200 mm silicon semiconductor wafer substrate in a Novellus “Sequel” model, 6-station dual-frequency PECVD apparatus. The substrate surface before processing comprised silicon. The FSG was deposited at a wafer temperature of about 400° C. Precursor reactant gases were flowed into the process reaction chamber at the following flow rates of pure gases: SiH₄, 180 sccm; CO₂, 16,000 sccm; and SiF₄, 780 sccm. HF RF power of 1200 Watts was applied to the showerhead at a frequency of 13.56 MHz, and LF RF power of 1300 Watts was applied to the substrate holder at a frequency of 250 kHz. A pressure of about 3.25 Torr was maintained in the reaction chamber.

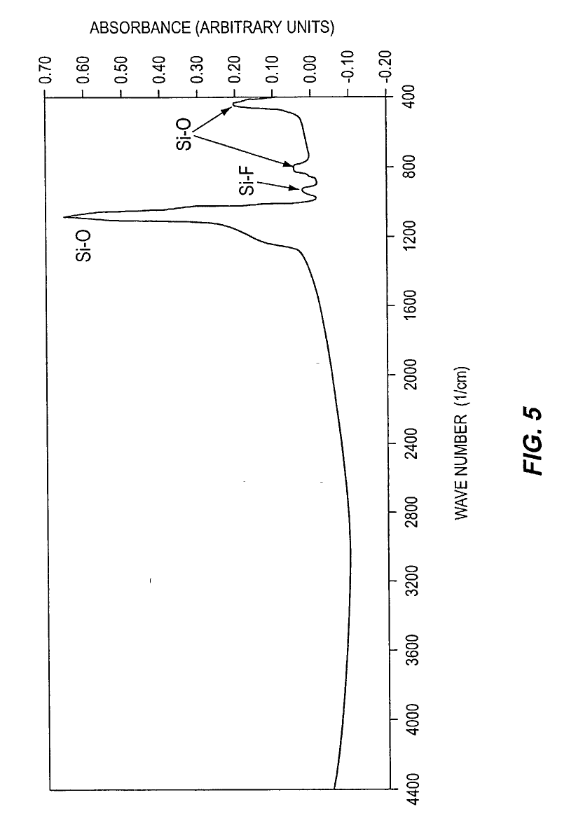

The resulting N-free FSG layer had a thickness of about 500 nm, and a dielectric constant of about 3.56. A FTIR analysis of the exemplary FSG layer was conducted, and the measured results are shown in FIG. 5. The graph of FIG. 5 shows peaks corresponding to Si—O and Si—F bonds, but no detected peaks corresponding to any bonds of nitrogen.

### EXAMPLE 2

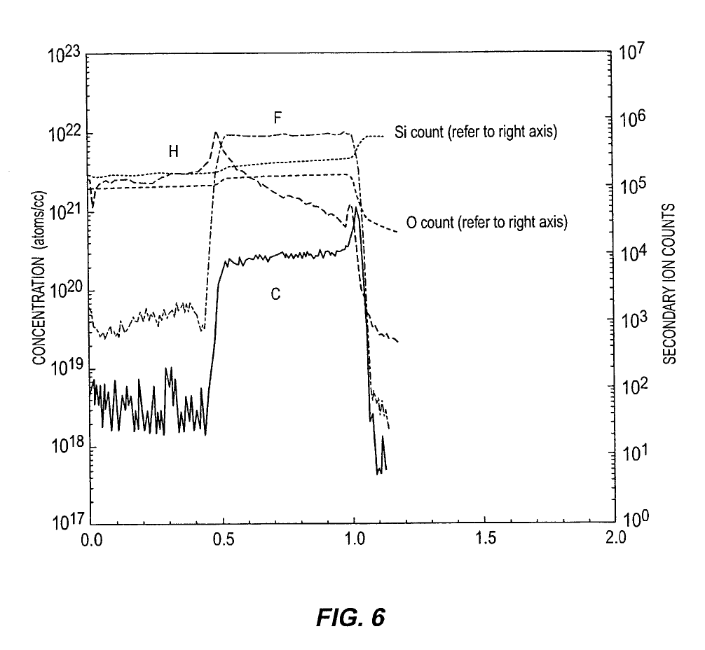

A N-free FSG film having a thickness of about 550 nm was deposited on a silicon substrate using conditions similar to those in Example 1. The N-free FSG film was capped by a 500-nm thick layer of oxide capping layer. A SIMS-profile was conducted on the resulting structure. In the graph of FIG. 6, the atomic concentration of carbon, hydrogen, and fluorine, as well as the secondary ion count associated with silicon and oxygen, were plotted as a function of structure depth. No nitrogen species was detected, which indicated that any nitrogen species was present at a level of less than about 1 ppm:

A method in accordance with the invention is useful in single-station and multi-station sequential deposition systems for 150 mm, 200 mm, 300 mm, and larger wafer substrates. Although embodiments in accordance with the invention were described herein mainly with reference to a PECVD apparatus and a PECVD method, other embodiments in accordance with the invention are practiced using a HDP-CVD apparatus and HDP-CVD operating conditions. In a HDP-CVD method in accordance with the invention, typical substrate temperature is maintained in a range of about from 200° C. to 450° C., preferably about 400° C., and reactor chamber pressure is in a range of about 2 mtorr to 10 mTorr, preferably 5 mTorr. LF RF power is applied to the reactor chamber at a frequency in a range of about from 2 MHz to 10 MHz and a power level in a range of about from 5 Watts per cm² to 18 Watts per cm² of substrate surface. HF RF bias is applied to the substrate at a frequency in a range of about 13.56 MHz, and at a power level in a range of about from 1 Watt per cm² to 8 Watts per cm² of substrate surface. The flow rate of SiH₄ is typically in a range of about from 0 sccm to 70 sccm; SiF₄ flow rate is typically in a range of about from 50 sccm to 250 sccm. The flow rate of CO₂ is typically in a range of about from 50 sccm to 400 sccm. The relative flow rate ratio SiH₄/CO₂/SiF₄ of preferred reactant gases in a HDP-CVD method is preferably in a range of about from 1/3/1 to 1/10/5, more preferably at a relative flow rate ratio SiH₄/CO₂/SiF₄ of about 1/5/3. In certain embodiments, only CO₂ and SiF₄ gases (i.e., no SiH₄ flow) are utilized in a HDP-process of N-free FSG deposition, whereby the preferred relative flow rate ratio CO₂/SiF₄ is in a range of about from 1.5 to 4/1.

Argon, helium, and another inert gas is typically flowed into the HDP reaction chamber in embodiments involving feature-filling, such as trench filling, in order to keep the feature open during deposition of FSG. The flow rate of argon, helium, or other inert gas is typically in a range of about from 0 sccm to 500 sccm, whereby a preferred relative flow rate ratio Ar (He, other inert)/SiF₄ is about 0.7 to 1.5/1.

Methods and N-free FSG material fabricated in accordance with the invention are useful in a wide variety of circumstances and applications. It is evident that those skilled in the art may now make numerous uses and modifications of the specific embodiments described, without departing from the inventive concepts. It is also evident that the steps recited may, in some instances, be performed in a different order; or equivalent structures and processes may be substituted for the structures and processes described. Since certain changes may be made in the above systems and methods without departing from the scope of the invention, it is intended that all subject matter contained in the above description or shown in the accompanying drawings be interpreted as illustrative and not in a limiting sense. Consequently, the invention is to be construed as embracing each and every novel feature and novel combination of features present in or inherently possessed by the systems, methods, and compositions described in the claims below and by their equivalents.

We claim:

1. A method of forming nitrogen-free fluorosilicate glass, comprising:
flowing nitrogen-free gases containing silicon atoms, oxygen atoms, and fluorine atoms to a nitrogen-free reaction chamber; and
forming a plasma containing silicon atoms, oxygen atoms, and fluorine atoms in said nitrogen-free reaction chamber.

2. A method as in claim 1 wherein said flowing nitrogen-free gases containing silicon atoms, oxygen atoms, and fluorine atoms comprises flowing gaseous silicon-containing molecules, flowing gaseous oxygen-containing molecules, and flowing gaseous fluorine-containing molecules to said reaction chamber.

3. A method as in claim 1 wherein said flowing nitrogen-free gases containing silicon atoms, oxygen atoms, and fluorine atoms comprises:
flowing a nitrogen-free gas selected from the group consisting of TEOS, TMOS, and tetramethylsilane;
flowing a nitrogen-free oxidizer gas selected from the group consisting of CO₂, CO, methanol, H₂O, O₂, and O₃; and
flowing a nitrogen-free fluorine-containing gas selected from the group consisting of CF₄, C₂F₆, C₄F₈, CHF₃, CH₂F₂.

4. A layer of nitrogen-free fluorosilicate glass formed by the method of claim 3.

5. A method as in claim 1 wherein said reaction chamber is a PECVD reaction chamber.

6. A method as in claim 5 wherein said flowing nitrogen-free gases containing silicon atoms, oxygen atoms, and fluorine atoms comprises:
flowing SiH₄ gas;
flowing a nitrogen-free oxidizer gas; and
flowing SiF₄ gas.

7. A method as in claim 6 wherein said flowing a nitrogen-free oxidizer gas comprises flowing CO₂ to said reaction chamber.

8. A method as in claim 7 wherein said flowing SiH₄, CO₂, and SiF₄ gases to said reaction chamber comprise flowing said gases at a relative flow rate ratio SiH₄/CO₂/SiF₄ in ranges of about from 1/30/2 to 1/500/40.

9. A method as in claim 7 wherein said flowing SiH₄, CO₂, and SiF₄ gases to said reaction chamber comprise flowing said gases at a relative flow rate ratio SiH₄/CO₂/SiF₄ in ranges of about from 1/40/3 to 1/90/10.

10. A method as in claim 7 wherein said flowing SiH₄, CO₂, and SiF₄ gases to said reaction chamber comprise flowing said gases at a relative flow rate ratio SiH₄/CO₂/SiF₄ of about 1/90/4.

11. A method as in claim 5, further comprising maintaining a process pressure in said reaction chamber in a range of about from 0.1 Torr to 10 Torr.

12. A method as in claim 5, further comprising maintaining a process pressure in said reaction chamber at about 3.25 Torr.

13. A method as in claim 5, further comprising maintaining a temperature of a substrate in said reaction chamber in a range of about from 200° C. to 500° C.

14. A method as in claim 5, further comprising maintaining a temperature of a substrate in said reaction chamber in a range of about from 350° C. to 450° C.

15. A method as in claim 5 wherein said forming a plasma comprises applying high-frequency radio-frequency power to said reaction chamber.

16. A method as in claim 15, further characterized in that said applying high-frequency radio-frequency power comprises applying power having a frequency in a range of about from 1 MHz to 100 MHz.

17. A method as in claim 15, further characterized in that said applying high-frequency radio-frequency power comprises applying power having a frequency in a range of about from 2 MHz to 30 MHz.

18. A method as in claim 15, further characterized in that said applying high-frequency radio-frequency power comprises applying power having a frequency of about 13.6 MHz.

19. A method as in claim 15, further characterized in that said applying high-frequency radio-frequency power comprises applying power in a range of about from 0.2 Watts per cm² to 5 Watts per cm² of a substrate surface.

20. A method as in claim 5 wherein said forming a plasma comprises applying low-frequency radio-frequency power to said reaction chamber.

21. A method as in claim 20 wherein said applying low-frequency radio-frequency power comprises applying low-frequency radio-frequency power having a frequency in a range of about from 100 kHz to 1 MHz.

22. A method as in claim 20 wherein said applying low-frequency radio-frequency power comprises applying low-frequency radio-frequency power having a frequency of about 250 kHz.

23. A method as in claim 20, further characterized in that said applying low-frequency radio-frequency power comprises applying power in a range of about from 0.2 Watts per cm² to 5 Watts per cm² of a substrate surface.

24. A layer of nitrogen-free fluorosilicate glass formed by the method of claim 5.

25. A method as in claim 1 wherein said reaction chamber is a HDP-CVD reaction chamber.

26. A method as in claim 25, further comprising maintaining a process pressure in said reaction chamber in a range of about from 2 mtorr to 10 mtorr.

27. A method as in claim 25, further comprising maintaining a temperature of a substrate in said reaction chamber in a range of about from 200° C. to 450° C.

28. A method as in claim 25 wherein said forming a plasma comprises applying low-frequency radio-frequency power to said reaction chamber.

29. A method as in claim 28, further characterized in that said applying low-frequency radio-frequency power comprises applying power having a frequency in a range of about from 2 MHz to 10 MHz.

30. A method as in claim 28, further characterized in that said applying low-frequency radio-frequency power comprises applying power in a range of about from 5 Watts per cm² to 18 Watts per cm² of a substrate surface.

31. A method as in claim 25 wherein said forming a plasma comprises applying high-frequency radio-frequency power to said substrate.

32. A method as in claim 31 wherein said applying high-frequency radio-frequency power comprises applying high-frequency radio-frequency power having a frequency of about 13.56 MHz.

33. A method as in claim 31 wherein said applying high-frequency radio-frequency power comprises applying high-frequency radio-frequency power in a range of about from 1 Watt per cm² to 8 Watts per cm² of a substrate.

34. A method as in claim 25 wherein said flowing nitrogen-free gases containing silicon atoms, oxygen atoms, and fluorine atoms comprises:
flowing CO₂ gas; and
flowing SiF₄ gas.

35. A method as in claim 34, further comprising flowing SiH₄ gas.

36. A layer of nitrogen-free fluorosilicate glass formed by the method of claim 25.

37. A layer of nitrogen-free fluorosilicate glass, comprising:
a Si—O bond; and
a Si—F bond;
and further characterized in being nitrogen-free.
